(19) United States
(12) Patent Application Publication
(10) Pub. No.: US 2024/0089058 A1
(43) Pub. Date: Mar. 14, 2024

(54) METHOD AND DEVICE IN NODES USED FOR WIRELESS COMMUNICATION

(71) Applicants: Qi JIANG, SHANGHAI (CN); Xiaobo ZHANG, Shanghai (CN)

(72) Inventors: Qi JIANG, SHANGHAI (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/509,334

(22) Filed: Nov. 15, 2023

Related U.S. Application Data
(63) Continuation of application No. PCT/CN22/93186, filed on May 17, 2022.

(30) Foreign Application Priority Data
May 18, 2021 (CN) 202110541251.0

(51) Int. Cl. H04L 5/00; H04B 7/06; H04W 76/20

(52) U.S. Cl. CPC H04L 5/0051; H04B 7/06968; H04W 76/20

(57) ABSTRACT

A node first receives a first signal, the first signal is used to determine a first identity, the first identity is associated with a first identifier and a second identifier; and then determines a target identifier from the first identifier or the second identifier; and receives a second signal; the first identifier and the second identifier are respectively associated with a first reference signal resource set and a second reference signal resource set; the first reference signal resource set is associated with the first identity; the first identity is a physical cell identifier of a first cell; a demodulation reference signal of a channel occupied by the second signal is quasi co-located with a target reference signal resource. Application improves the configuration of a serving cell identifier under M-TRP (multi-transmitting and receiving node) to optimize system performance.

### CROSS REFERENCE TO RELATED APPLICATIONS

This application is the continuation of the international patent application No. PCT/CN2022/093186, filed on May 17, 2022, and claims the priority benefit of Chinese Patent Application No. 202110541251.0, filed on May 18, 2021, the full disclosure of which is incorporated herein by reference.

### BACKGROUND

### Technical Field

The present application relates to transmission methods and devices in wireless communication systems, and in particular to a design scheme and device of a cell identifier in wireless communications.

### Related Art

In 5G New Radio (NR), Massive Multi-Input Multi-Output (MIMO) is a key technology. In the Massive MIMO, multiple antennas based on beamforming to form a relatively narrow beam which points to a particular direction to improve the quality of communications. In 5G NR, in addition to defining Radio Link Failure (RLF) related operations, Beam Link Failure (BLF) related operations are also defined to optimize beam selection and beam management in beamforming scenarios.

In the discussion of NR R17, for the scenario of Multi-TRP (transmitting and receiving node), issues related to inter-cell operations are being discussed. In RAN1 #104b-e meeting, another extra Physical Cell Identifier (PCI) different from a PCI of a serving cell was introduced.

### SUMMARY

Inventors have found through researches that the above extra PCI will be associated with one or multiple Transmission Configuration Indication (TCI) states for channel measurement. For the above extra PCI, one implementation method is that the above extra PCI is associated with a neighbor cell of a serving cell, so as to implement that the terminal does not need to trigger handover when moving between a serving cell and a neighbor cell. However, in current NR system, the configuration methods related to TCI State, whether it is a Radio Resource Control (RRC) signaling or a Medium Access Control (MAC) layer signaling, is configured based on a serving cell, meaning that TCI configuration and activation are all executed based on a SCellIndex. Currently, the impact of the introduction of the extra PCI has not been considered in NR system.

To address the above problem, the present application provides a solution. It should be noted that although the above description uses Massive MIMO and beam-based communication scenarios as examples, the application is also applicable to other scenarios, such as LTE multi-antenna system, where similar technical effects can be achieved. Additionally, the adoption of a unified solution for various scenarios (including but not limited to Massive MIMO, beam-based communications and LTE multi-antenna system) contributes to the reduction of hardware complexity and costs. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

To solve the above problems, the present application discloses a design method and device used for cell identifier under multi-TRP. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict. Though originally targeted at cellular network, the present application is also applicable to Internet of Things (IoT) and Internet of Vehicles (IoV). Though originally targeted at multi-carrier communications, the present application is also applicable to single-carrier communications. Though originally targeted at multi-antenna communications, the present application is also applicable to single-antenna communications. Besides, the present application is not only targeted at scenarios of terminals and base stations, but also at communication scenarios between terminals and terminals, terminals and relays, Non-Terrestrial Networks as well as relays and base stations, where similar technical effects can be achieved. Additionally, the adoption of a unified solution for various scenarios, including but not limited to communication scenarios between terminals and base stations, contributes to the reduction of hardware complexity and costs.

Further, the embodiments of a first node in the present application and the characteristics of the embodiments may be applied to a second node if no conflict is incurred, and vice versa. Particularly, for interpretations of the terminology, nouns, functions and variants (if not specified) in the present application, refer to definitions given in Technical Specification (TS) 36 series, TS38 series and TS37 series of 3GPP specifications.

The present application provides a method in a first node for wireless communications, comprising:
receiving a first signal, the first signal being used to determine a first identity, the first identity being associated with a first identifier and a second identifier;
determining a target identifier from the first identifier or the second identifier; and
receiving a second signal;
herein, the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, one technical feature of the above method is in: configuring two serving cell identifiers for the first cell, that is, the first identifier and the second identifier; both the first identifier and the second identifier are used for TCI configuration and activation to simplify system operation and avoid handover during inter-cell mobility, and the technical effect of flexibly switching serving beams of the first node between two actual cells is achieved only through a MAC signaling or an RRC signaling.

In one embodiment, another technical feature of the above method is in: the first identifier is associated with a TCI under the first cell, and the second identifier is associated with a TCI under a neighboring cell of the first cell; furthermore, by comprising an RRC signaling or a MAC signaling of the second identifier, a TCI of a neighboring cell can be updated without triggering handover, so as to improve system performance and efficiency.

According to one aspect of the present application, comprising:
receiving a first information block, the first information block being used to determine the target identifier from the first identifier and the second identifier;
herein, the first information block is a last first-type information block received by the first node before the second signal.

In one embodiment, one technical feature of the above method is in: the first node determines a TCI-State adopted by the second signal according to a latest received RRC or MAC signaling.

According to one aspect of the present application, the target identifier is a predefined one of the first identifier and the second identifier.

In one embodiment, one technical feature of the above method is in: when the first information block comprises both the first identifier and the second identifier, the first node adopts a predefined method to avoid uncertainty about a TCI-State adopted by the second signal.

According to one aspect of the present application, the first cell is associated with a second identity, any second reference signal resource comprised in the second reference signal resource set is associated with the second identity, the second identity is different from the first identity, and the second identity and the first identity occupy a same number of bit(s).

In one embodiment, one technical feature of the above method is in: the second identity corresponds to an extra PCI of the first cell, and the second identity is associated with a neighboring cell of the first cell, that is, implicitly indicating to the first node through the second identity that the second reference signal resource set associated with the second identity is a beam maintained by a neighboring cell of the first cell.

According to one aspect of the present application, only the first identifier in the first identifier and the second identifier is associated with a first index, the first index is used to indicate the first cell, and the first index is used for cross-carrier scheduling.

In one embodiment, one technical feature of the above method is in: the first cell only has one serving cell identifier, that is, the first identifier is used in cross-carrier scheduling to avoid incorrect understanding of a scheduling signaling.

According to one aspect of the present application, comprising:
receiving a first signaling;
herein, the first signaling is used to determine K1 serving cells, K1 being a positive integer greater than 1, the first cell is a serving cell other than the K1 serving cells, the K1 serving cells respectively correspond to K1 cell identifiers, and the second identifier is different from any cell identifier in the K1 cell identifiers.

In one embodiment, one technical feature of the above method is in: the second identifier is not used for serving cell identifiers of other serving cells to avoid misunderstanding in configuring a signaling.

According to one aspect of the present application, comprising:
receiving a second signaling;
herein, the second signaling is used to determine a first control resource set, and the first control resource set is associated with the first identifier and the second identifier at the same time; frequency-domain resources occupied by the second signal belong to the first control resource set, and a measurement for the first cell is used to determine the target identifier.

In one embodiment, one technical feature of the above method is in: the first control resource set is associated with the first identifier and the second identifier at the same time, a MAC signaling comprising the first identifier and/or the second identifier can update and receive a Physical Downlink Control Channel (PDCCH) in the first control resource set, and the first control resource set can be transmitted a PDCCH by the first cell and a neighboring cell of the first cell at the same time; the above method reduces overhead of a control signaling and improves spectral efficiency.

The present application provides a method in a second node for wireless communications, comprising:
transmitting a first signal, the first signal being used to determine a first identity, the first identity being associated with a first identifier and a second identifier;
determining a target identifier from the first identifier or the second identifier; and
transmitting a second signal;
herein, the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

According to one aspect of the present application, comprising:
transmitting a first information block, the first information block being used to determine the target identifier from the first identifier and the second identifier;
herein, the first information block is a last first-type information block received by the first node before the second signal.

According to one aspect of the present application, the target identifier is a predefined one of the first identifier and the second identifier.

According to one aspect of the present application, the first cell is associated with a second identity, any second reference signal resource comprised in the second reference signal resource set is associated with the second identity, the second identity is different from the first identity, and the second identity and the first identity occupy a same number of bit(s).

According to one aspect of the present application, only the first identifier in the first identifier and the second identifier is associated with a first index, the first index is used to indicate the first cell, and the first index is used for cross-carrier scheduling.

According to one aspect of the present application, comprising:
transmitting a first signaling;
herein, the first signaling is used to determine K1 serving cells, K1 being a positive integer greater than 1, the first cell is a serving cell other than the K1 serving cells, the K1 serving cells respectively correspond to K1 cell identifiers, and the second identifier is different from any cell identifier in the K1 cell identifiers.

According to one aspect of the present application, comprising:
transmitting a second signaling;
herein, the second signaling is used to determine a first control resource set, and the first control resource set is associated with the first identifier and the second identifier at the same time; frequency-domain resources occupied by the second signal belong to the first control resource set, and a measurement for the first cell is used to determine the target identifier.

The present application provides a first node for wireless communications, comprising:
a first receiver, receiving a first signal, the first signal being used to determine a first identity, the first identity being associated with a first identifier and a second identifier;
a second receiver, determining a target identifier from the first identifier or the second identifier; and
a third receiver, receiving a second signal;
herein, the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

The present application provides a second node for wireless communications, comprising:
a first transmitter, transmitting a first signal, the first signal being used to determine a first identity, the first identity being associated with a first identifier and a second identifier;
a second transmitter, determining a target identifier from the first identifier or the second identifier; and
a third transmitter, transmitting a second signal;
herein, the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, the present application has the following advantages over conventional schemes:
configuring two serving cell identifiers for the first cell, that is, the first identifier and the second identifier; the first identifier and the second identifier are both used for TCI configuration and activation to simplify system operation and avoid switching during inter-cell mobility, and the technical effect of flexibly switching serving beams of the first node between two actual cells is achieved only through a MAC signaling or an RRC signaling;
the first identifier is associated with a TCI under the first cell, and the second identifier is associated with a TCI under a neighboring cell of the first cell; furthermore, by comprising an RRC signaling or a MAC signaling of the second identifier, a TCI of a neighboring cell can be updated without triggering handover, so as to improve system performance and efficiency;
the second identity corresponds to an extra PCI of the first cell, and the second identity is a neighboring cell associated with the first cell, that is, implicitly indicating to the first node through the second identity that the second reference signal resource set associated with the second identity is a beam maintained by a neighboring cell of the first cell;
the first cell only has one serving cell identifier used for cross-carrier scheduling, that is, the first identifier is used in cross-carrier scheduling to avoid incorrect understanding of a scheduling a signaling;
the first control resource set is associated with the first identifier and the second identifier at the same time, a MAC signaling comprising the first identifier and/or the second identifier can update and receive a PDCCH in the first control resource set, and the first control resource set can be transmitted a PDCCH by the first cell and a neighboring cell of the first cell at the same time; the above method reduces overhead of a control signaling and improves spectral efficiency.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a second signal according to one embodiment of the present application;

FIG. 6 illustrates a flowchart of a first information block according to one embodiment of the present application;

FIG. 7 illustrates a flowchart of a first signaling according to one embodiment of the present application;

FIG. 8 illustrates a flowchart of a second signaling according to one embodiment of the present application;

FIG. 9 illustrates a schematic diagram of a target reference signal resource set according to one embodiment of the present application;

FIG. 10 illustrates a schematic diagram of a first reference signal resource set and a second reference signal resource set according to one embodiment of the present application;

FIG. 11 illustrates a schematic diagram of an application scenario according to one embodiment of the present application;

FIG. 12 is a schematic diagram of a first identifier and a second identifier according to one embodiment of the present application;

FIG. 13 illustrates a structure block diagram of a processor in a first node according to one embodiment of the present application;

FIG. 14 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

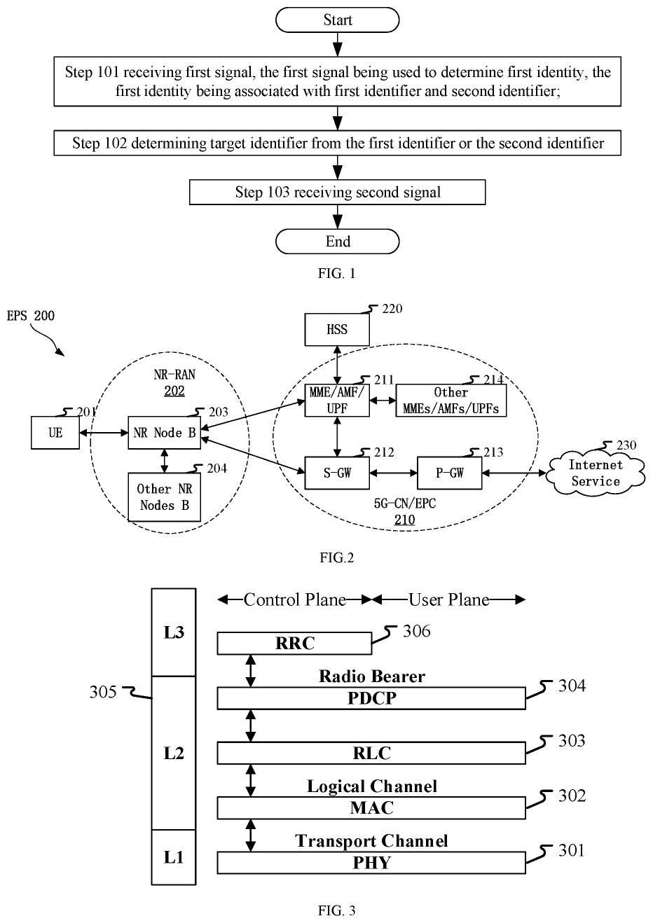

Embodiment 1 illustrates flowchart of the processing of a first node, as shown in FIG. 1. In step 100 illustrated by FIG. 1, each box represents a step. In embodiment 1, the first node in the present application receives a first signal in step 101, the first signal is used to determine a first identity, the first identity is associated with a first identifier and a second identifier; and determines a target identifier from the first identifier or the second identifier in step 102; receives a second signal in step 103.

In embodiment 1, the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, the first signal comprises a Synchronization Signal/physical broadcast channel Block (SSB).

In one embodiment, the first signal is transmitted through an RRC signaling.

In one embodiment, the first signal comprises the first identity.

In one embodiment, an RRC signaling used for transmitting the first signal comprises ServingCellConfigCommon Information Elements (IEs) in TS 38.331.

In one embodiment, an RRC signaling used for transmitting the first signal comprises a SCellConfig field in TS 38.331.

In one embodiment, an RRC signaling used for transmitting the first signal comprises a CellGroupConfig IE in TS 38.331.

In one embodiment, a demodulation for the first signal is used to determine the first identity.

In one embodiment, a detection for the first signal is used to determine the first identity.

In one embodiment, the first identity is a non-negative integer.

In one embodiment, a number of bit(s) occupied by the first identity is 16 bytes.

In one embodiment, the first identity is a PCI.

In one embodiment, the first identity is a PCI adopted by a serving cell.

In one embodiment, the first identity is used to generate a reference signal transmitted in any first reference signal resource in the first reference signal resource set.

In one embodiment, the meaning of the above phrase that the first identity is associated with a first identifier and a second identifier comprises: a serving cell corresponding to the first identity is simultaneously configured with the first identifier and the second identifier.

In one embodiment, the meaning of the above phrase that the first identity is associated with a first identifier and a second identifier comprises: SCellIndex of a serving cell corresponding to the first identity simultaneously comprises the first identifier and the second identifier.

In one embodiment, the meaning of the above phrase that the first identity is associated with a first identifier and a second identifier comprises: ServcellIndex of a serving cell corresponding to the first identity simultaneously comprises the first identifier and the second identifier.

In one embodiment, the meaning of the above phrase that the first identity is associated with a first identifier and a second identifier comprises: SCellIndex of a subcarrier corresponding to the first identity simultaneously comprises the first identifier and the second identifier.

In one embodiment, the meaning of the above phrase that the first identity is associated with a first identifier and a second identifier comprises: ServcellIndex of a frequency band corresponding to the first identity simultaneously comprises the first identifier and the second identifier.

In one embodiment, the meaning of the above phrase that the first identity is associated with a first identifier and a second identifier comprises: simultaneously indicating the first identifier and the second identifier in an RRC signaling configuring the first identity.

In one embodiment, the target identifier is one of the first identifier and the second identifier.

In one embodiment, the first identifier is SCellIndex.

In one embodiment, the first identifier is ServcellIndex.

In one embodiment, the first identifier is a non-negative positive integer not less than 32.

In one embodiment, the first identifier is equal to 0.

In one embodiment, the first identifier occupies 5 bits.

In one embodiment, the second identifier is SCellIndex.

In one embodiment, the second identifier is ServcellIndex.

In one embodiment, the second identifier is a non-negative positive integer not less than 32.

In one embodiment, the second identifier is equal to 0.

In one embodiment, the second identifier occupies 5 bits.

In one embodiment, a physical-layer channel occupied by the second signal comprises a PDCCH.

In one embodiment, a physical-layer channel occupied by the second signal comprises a Physical Downlink Shared Channel (PDSCH).

In one embodiment, the second signal is Downlink Control Information (DCI).

In one embodiment, a transport channel occupied by the second signal comprises a Downlink Shared Channel (DL-SCH).

In one embodiment, the meaning of the above phrase that the first identifier and the second identifier are respectively associated with a first reference signal resource set and a second reference signal resource set comprises: an RRC signaling configuring the first reference signal resource set also indicates the first identifier, and an RRC signaling configuring the second reference signal resource set also indicates the second identifier.

In one embodiment, the meaning of the above phrase that the first identifier and the second identifier are respectively associated with a first reference signal resource set and a second reference signal resource set comprises: the first identifier is used to generate a reference signal transmitted in any reference signal resource in the first reference signal resource set, and the second identifier is used to generate a reference signal transmitted in any reference signal resource in the second reference signal resource set.

In one embodiment, the first reference signal resource set comprises M1 first reference signal resource(s).

In one subembodiment of the embodiment, M1 is a positive integer greater than 1.

In one subembodiment of the embodiment, M1 is equal to 1.

In one embodiment, any of the M1 first reference signal resource(s) comprises a Channel State Information Reference Signal (CSI-RS) resource.

In one subembodiment of the embodiment, any of the M1 first reference signal resource(s) comprises a Demodulation Reference Signal (DMRS) resource.

In one subembodiment of the embodiment, any of the M1 first reference signal resource(s) comprises a Sounding Reference Signal (SRS) resource.

In one subembodiment of the embodiment, any of the M1 first reference signal resource(s) comprises an SSB.

In one subembodiment of the embodiment, any of the M1 first reference signal resource(s) corresponds to a TCI.

In one subembodiment of the embodiment, any of the M1 first reference signal resource(s) corresponds to a TCI-State.

In one subembodiment of the embodiment, any of the M1 first reference signal resource(s) corresponds to a TCI-StateId.

In one embodiment, the second reference signal resource set comprises M2 first reference signal resource(s).

In one subembodiment of the embodiment, M2 is a positive integer greater than 2.

In one subembodiment of the embodiment, M2 is equal to 1.

In one subembodiment of the embodiment, any of the M2 second reference signal resource(s) comprises a CSI-RS resource.

In one subembodiment of the embodiment, any of the M2 second reference signal resource(s) comprises a DMRS resource.

In one subembodiment of the embodiment, any of the M2 second reference signal resource(s) comprises an SRS resource.

In one subembodiment of the embodiment, any of the M2 second reference signal resource(s) comprises an SSB.

In one subembodiment of the embodiment, any of the M2 second reference signal resource(s) corresponds to a TCI.

In one subembodiment of the embodiment, any of the M2 second reference signal resource(s) corresponds to a TCI-State.

In one subembodiment of the embodiment, any of the M2 second reference signal resource(s) corresponds to a TCI-StateId.

In one embodiment, the meaning of the above phrase that only a first reference signal resource comprised in the first reference signal resource set in the first reference signal resource set and the second reference signal resource set is associated with the first identity comprises: an RRC signaling configuring the first reference signal resource set only comprises one PCI, and the PCI is the first identity.

In one embodiment, the meaning of the above phrase that only a first reference signal resource comprised in the first reference signal resource set in the first reference signal resource set and the second reference signal resource set is associated with the first identity comprises: a reference signal transmitted in any of the first reference signal resource in the first reference signal resource set is only generated by one PCI, and the PCI is the first identity.

In one embodiment, the meaning of the above phrase that only a first reference signal resource comprised in the first reference signal resource set in the first reference signal resource set and the second reference signal resource set is associated with the first identity comprises: any first reference signal resource configuring the first reference signal resource set is associated with a TCI-State, an RRC signaling configuring the TCI-State only comprises one PCI, and the PCI is the first identity.

In one embodiment, a type of quasi co-location between a demodulation reference signal of a channel occupied by the second signal and a target reference signal resource is Quasi Co-located (QCL) Type D.

In one embodiment, a type of quasi co-location between a demodulation reference signal of a channel occupied by the second signal and a target reference signal resource is QCL Type A.

In one embodiment, a type of quasi co-location between a demodulation reference signal of a channel occupied by the second signal and a target reference signal resource is QCL Type B.

In one embodiment, a type of quasi co-location between a demodulation reference signal of a channel occupied by the second signal and a target reference signal resource is QCL Type C.

In one embodiment, the first node determines that the target identifier is the first identifier, the target reference signal resource set is the first reference signal resource set, and the target reference signal resource is a first reference signal resource set comprised in the first reference signal resource set.

In one embodiment, the first node determines that the target identifier is the second identifier, the target reference signal resource set is the second reference signal resource set, and the target reference signal resource set is a second reference signal resource set comprised in the second reference signal resource set.

In one embodiment, the first cell is a serving cell.

In one embodiment, the first cell is a PCell.

In one embodiment, the first cell is a PSCell.

In one embodiment, reference signals in the first reference signal resource set and reference signals in the second reference signal resource set are both transmitted in frequency-domain resources corresponding to the first cell.

In one embodiment, reference signals in the first reference signal resource set and reference signals in the second reference signal resource set are respectively transmitted by the first cell and second cell, and the second cell is a neighboring cell the first cell.

In one subembodiment of the embodiment, a PCI of the second cell is equal to the second identity in the present application.

In one embodiment, the first signal is a radio signal.

In one embodiment, the first signal is a baseband signal.

In one embodiment, the second signal is a radio signal.

In one embodiment, the second signal is a baseband signal.

### Embodiment 2

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMES/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 can receive PDCCHs from multiple TRPs at the same time.

In one embodiment, the UE 201 can receive CSI-RSs from multiple TRPs at the same time.

In one embodiment, the UE 201 can receive SSBs from multiple TRPs at the same time.

In one embodiment, the UE 201 is a terminal capable of monitoring multiple beams at the same time.

In one embodiment, the UE 201 is a terminal supporting Massive-MIMO.

In one embodiment, the UE 201 is a terminal supporting Vehicle-to-Everything (V2X).

In one embodiment, the gNB 203 corresponds to the second node in the present application.

In one embodiment, the gNB 203 can transmit PDCCHs from multiple TRPs at the same time.

In one embodiment, multiple TRPs comprised in the gNB 203 can transmit CSI-RSs at the same time.

In one embodiment, multiple TRPs comprised in the gNB 203 can transmit SSBs at the same time.

In one embodiment, the gNB 203 supports a transmission of multi-beam.

In one embodiment, the gNB 203 supports a transmission based on Massive-MIMO.

In one embodiment, the gNB 203 comprises at least two TRPs.

In one embodiment, at least two TRPs comprised in the gNB 203 are connected through an ideal backhaul

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used to generate scheduling of the first communication node.

In one embodiment, the PDCP 354 of the second communication node is used to generate scheduling of the first communication node.

In one embodiment, the first signal is generated by the MAC 302 or the MAC 352.

In one embodiment, the first signal is generated by the RRC 306.

In one embodiment, the second signal is generated by the PHY 301 or the PHY 351.

In one embodiment, the second signal is generated by the MAC 302 or the MAC 352.

In one embodiment, the second signal is generated by the RRC 306.

In one embodiment, the first signaling is generated by the PHY 301 or the PHY 351.

In one embodiment, the first signaling is generated by the MAC 302 or the MAC 352.

In one embodiment, the first signaling is generated by the RRC 306.

In one embodiment, the second signaling is generated by the PHY 301 or the PHY 351.

In one embodiment, the second signaling is generated by the MAC 302 or the MAC 352.

In one embodiment, the second signaling is generated by the RRC 306.

In one embodiment, the first node is a terminal.

In one embodiment, the second node is a terminal.

In one embodiment, the second node is a Road Side Unit (RSU).

In one embodiment, the second node is a Grouphead.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used to manage multiple TRPs.

In one embodiment, the second node is a node used for managing multiple cells.

### Embodiment 4

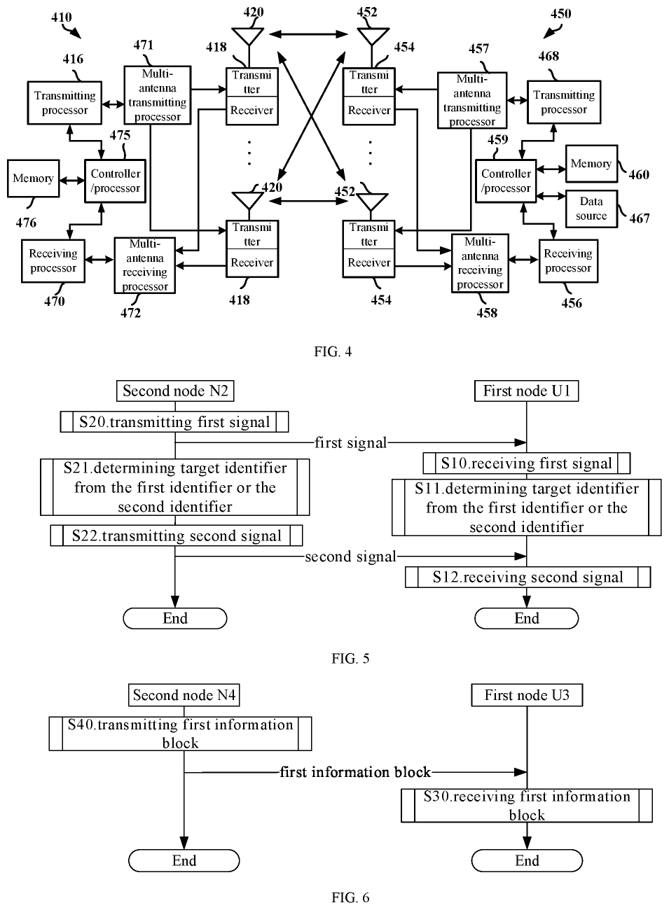

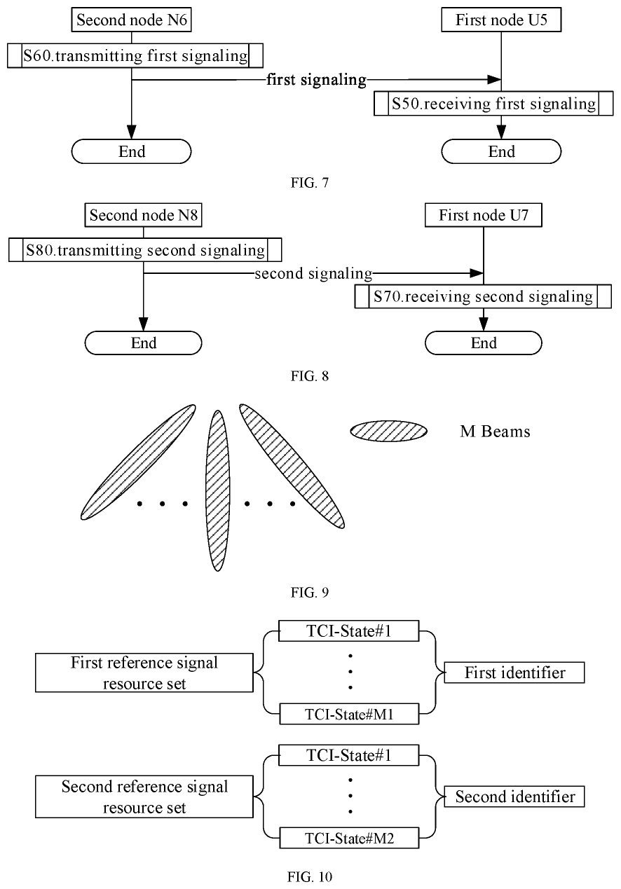

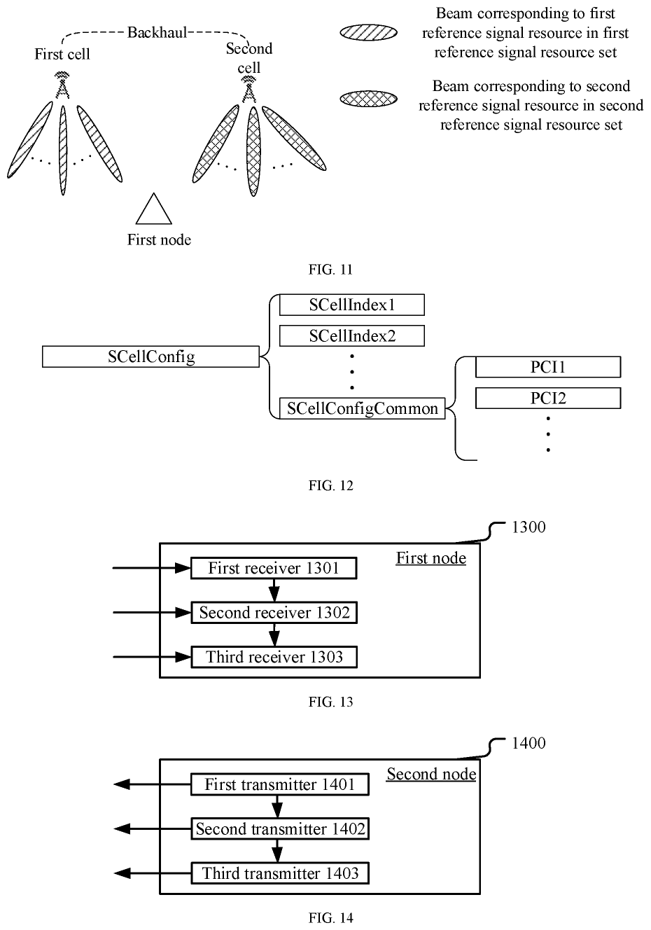

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first signal, the first signal is used to determine a first identity, the first identity is associated with a first identifier and a second identifier; and then determines a target identifier from the first identifier or the second identifier; and receives a second signal; the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, the first communication device 450 comprises at least one processor and at least one memory. a memory that stores a computer readable instruction program. The computer readable instruction program generates an action when executed by at least one processor. The action includes: first receiving a first signal, the first signal being used to determine a first identity, the first identity being associated with a first identifier and a second identifier; and then determining a target identifier from the first identifier or the second identifier; and receiving a second signal; the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first signal, the first signal is used to determine a first identity, the first identity is associated with a first identifier and a second identifier; and then determines a target identifier from the first identifier or the second identifier; and transmits a second signal; the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, the second communication device 410 comprises a memory that stores a computer readable instruction program. The computer readable instruction program generates an action when executed by at least one processor. The action includes: first transmitting a first signal, the first signal being used to determine a first identity, the first identity being associated with a first identifier and a second identifier; and then determining a target identifier from the first identifier or the second identifier; then transmitting a second signal; the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the second communication device 410 is a base station.

In one embodiment, the second communication device 410 is a UE.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first signal; at least first four of the antenna 420, the transmitter 418, the multi-antenna transmitting processor 471, the transmitting processor 416 and the controller/processor 475 are used to transmit a first signal.

In one embodiment, at least first four of the antenna 452, the receiver 454, the multi-antenna receiving processor 458, the receiving processor 456 and the controller/processor 459 are used to determine a target identifier from the first identifier or the second identifier; at least first four of the antenna 420, the transmitter 418, the multi-antenna transmitting processor 471, the transmitting processor 416 and the controller/processor 475 are used to determine a target identifier from the first identifier or the second identifier.

In one embodiment, at least first four of the antenna 452, the receiver 454, the multi-antenna receiving processor 458, the receiving processor 456 and the controller/processor 459 are used to receive a second signal; at least first four of the antenna 420, the transmitter 418, the multi-antenna transmitting processor 471, the transmitting processor 416 and the controller/processor 475 are used to transmit a second signal.

In one embodiment, at least first four of the antenna 452, the receiver 454, the multi-antenna receiving processor 458, the receiving processor 456 and the controller/processor 459 are used to receive a first information block; at least first four of the antenna 420, the transmitter 418, the multi-antenna transmitting processor 471, the transmitting processor 416 and the controller/processor 475 are used to transmit a first information block.

In one embodiment, at least first four of the antenna 452, the receiver 454, the multi-antenna receiving processor 458, the receiving processor 456 and the controller/processor 459 are used to receive a first signaling; at least first four of the antenna 420, the transmitter 418, the multi-antenna transmitting processor 471, the transmitting processor 416 and the controller/processor 475 are used to transmit a first signaling.

In one embodiment, at least first four of the antenna 452, the receiver 454, the multi-antenna receiving processor 458, the receiving processor 456 and the controller/processor 459 are used to receive a second signaling; at least first four of the antenna 420, the transmitter 418, the multi-antenna transmitting processor 471, the transmitting processor 416 and the controller/processor 475 are used to transmit a second signaling.

### Embodiment 5

Embodiment 5 illustrates a flowchart of a second signal, as shown in FIG. 5. In FIG. 5, a first node U1 and a second node N2 are in communications via a radio link. It is particularly underlined that the order illustrated in the embodiment does not put constraints over sequences of signal transmissions and implementations.

The first node U1 receives a first signal in step S10; determines a target identifier from the first identifier or the second identifier in step S11; receives a second signal in step S12.

The second node N2 transmits a first signal in step S20; determines a target identifier from the first identifier or the second identifier in step S21; transmits a second signal in step S22.

In embodiment 5, the first signal is used to determine a first identity, the first identity is associated with a first identifier and a second identifier; and the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, the target identifier is a pre-defined one in the first identifier and the second identifier.

In one subembodiment of the embodiment, the first information block comprises the first identifier and the second identifier at the same time, and the target identifier is a predefined one of the first identifier and the second identifier.

In one subsidiary embodiment of the subembodiment, the predefined identifier is the first identifier, the target identifier is the first identifier, and the target reference signal resource set is the first reference signal resource set.

In one subsidiary embodiment of the subembodiment, the predefined identifier is the second identifier, the target identifier is the second identifier, and the target reference signal resource set is the second reference signal resource set.

In one subsidiary embodiment of the subembodiment, the predefined identifier is one of the first identifier and the second identifier with a smaller value, the target identifier is an identifier in the first identifier and the second identifier with a smaller value, and the target reference signal resource is a reference signal resource set corresponding to a smaller identifier in the first identifier and the second identifier.

In one subembodiment of the embodiment, time-frequency resources occupied by the second signal are used to determine the target identifier.

In one subsidiary embodiment of the subembodiment, the time-frequency resources occupied by the second signal belong to a first time-frequency resource pool, and the target identifier is the first identifier.

In one example of the subsidiary embodiment, the first time-frequency resource pool is a Control Resource Set (CORESET).

In one example of the subsidiary embodiment, the first time-frequency resource pool is a CORESET pool.

In one example of the subsidiary embodiment, the first time-frequency resource pool is a search space set.

In one example of the subsidiary embodiment, the time-frequency resources occupied by the second signal belong to a second time-frequency resource pool, and the target identifier is the second identifier.

In one example of the subsidiary embodiment, the second time-frequency resource pool is a CORESET.

In one example of the subsidiary embodiment, the second time-frequency resource pool is a CORESET pool.

In one example of the subsidiary embodiment, the second time-frequency resource pool is a search space set.

In one subembodiment of the embodiment, the second signal is transmitted on a PDSCH, and a scheduling signaling of the PDSCH indicates the target identifier.

In one subsidiary embodiment of the subembodiment, the scheduling signaling of the PDSCH indicates the target identifier from the first identifier and the second identifier.

In one subsidiary embodiment of the subembodiment, the scheduling signaling of the PDSCH indicates the first identifier, and the target identifier is the first identifier.

In one subsidiary embodiment of the subembodiment, the scheduling signaling of the PDSCH indicates the second identifier, and the target identifier is the second identifier.

In one embodiment, the first cell is associated with a second identity, any second reference signal resource comprised in the second reference signal resource set is associated with the second identity, the second identity is different from the first identity, and the second identity and the first identity occupy a same number of bit(s).

In one subembodiment of the embodiment, the second identity is a non-negative integer.

In one subembodiment of the embodiment, a number of bit(s) occupied by the second identity is 16 bytes.

In one subembodiment of the embodiment, the second identity is a PCI.

In one subembodiment of the embodiment, the second identity is a PCI adopted by a non-serving cell.

In one subembodiment of the embodiment, the second identity is used to generate a reference signal transmitted in any second reference signal resource in the second reference signal resource set.

In one subembodiment of the embodiment, the meaning of the above phrase that the first cell is associated with a second identity comprises: the first cell is configured with the second identity.

In one subembodiment of the embodiment, the meaning of the above phrase that the first cell is associated with a second identity comprises: an RRC signaling configuring the first cell also comprises the second identity.

In one subsidiary embodiment of the subembodiment, the RRC signaling configuring the first cell comprises a ServingCellConfigCommon IE in TS 38.331.

In one subsidiary embodiment of the subembodiment, the RRC signaling configuring the first cell comprises a SCellConfig field in TS 38.331.

In one subsidiary embodiment of the subembodiment, the RRC signaling configuring the first cell comprises a CellGroupConfig IE in TS 38.331.

In one subembodiment of the embodiment, a synchronization signal transmitted by the first cell is not used to determine the second identity.

In one subembodiment of the embodiment, an SSB transmitted by the first cell is not used to determine the second identity.

In one subembodiment of the embodiment, the meaning of the above phrase that any second reference signal resource comprised in the second reference signal resource set is associated with the second identity comprises: an RRC signaling configuring the second reference signal resource set only comprises one PCI, and the PCI is the second identity.

In one subembodiment of the embodiment, the meaning of the above phrase that any second reference signal resource comprised in the second reference signal resource set is associated with the second identity comprises: a reference signal transmitted in any of the second reference signal resource in the second reference signal resource set is only generated by one PCI, and the PCI is the second identity.

In one subembodiment of the embodiment, the meaning of the above phrase that any second reference signal resource comprised in the second reference signal resource set is associated with the second identity comprises: any second reference signal resource configuring the second reference signal resource set is associated with a TCI-State, and an RRC signaling configuring the TCI-State only comprises one PCI, and the PCI is the second identity.

In one subembodiment of the embodiment, only the first identifier in the first identifier and the second identifier is associated with a first index, the first index is used to indicate the first cell, and the first index is used for cross-carrier scheduling.

In one subembodiment of the embodiment, the first index is used to indicate frequency-domain resources occupied by the first cell.

In one subembodiment of the embodiment, the second identifier is not associated with an index used for cross-carrier scheduling, and the index used for cross-carrier scheduling is a positive integer greater than 0 and less than 8.

### Embodiment 6

Embodiment 6 illustrates a flowchart of a first information block, as shown in FIG. 6. In FIG. 6, a first node U3 and a second node N4 are in communications via a radio link. It is particularly underlined that the order illustrated in the embodiment does not put constraints over sequences of signal transmissions and implementations.

The first node U3 receives a first information block in step S30;

The second node N4 transmits a first information block in step S40.

In embodiment 6, the first information block is used to determine the target identifier from the first identifier and the second identifier; the first information block is a last first-type information block received by the first node N3 before the second signal.

In one embodiment, the step S30 is taken before the step S11 in embodiment 5.

In one embodiment, the step S40 is taken before the step S21 in embodiment 5.

In one embodiment, the step S30 is taken after the step S10 in embodiment 5.

In one embodiment, the step S40 is taken after the step S20 in embodiment 5.

In one embodiment, the first-type information block is carried through a MAC Control Element (MAC CE).

In one embodiment, the first-type information block comprises a TCI State Activation/Deactivation of UE-Specific PDSCH MAC CE in TS 38.321.

In one embodiment, the first information block comprises a TCI State Indication for UE-Specific PDCCH MAC CE in TS 38.321.

In one embodiment, the first information block is carried through a MAC CE.

In one embodiment, the first information block comprises a TCI State Activation/Deactivation of UE-Specific PDSCH MAC CE in TS 38.321.

In one embodiment, the first information block comprises a TCI State Indication for UE-Specific PDCCH MAC CE in TS 38.321.

In one embodiment, a name of the first information block comprises TCI State.

In one embodiment, a name of the first information block comprises Indication.

In one embodiment, a name of the first information block comprises Activation/Deactivation.

In one embodiment, the first information block only comprises the first identifier in the first identifier and the second identifier, the target identifier is equal to the first identifier, and the target reference signal resource set is the first reference signal resource set.

In one subembodiment of the embodiment, the first information block is used to indicate a given first reference signal resource from the first reference signal resource set, and the target reference signal resource is the given first reference signal resource.

In one subembodiment of the embodiment, a scheduling signaling of the second signal is used to indicate a given first reference signal resource from the first reference signal resource set, and the target reference signal resource is the given first reference signal resource.

In one embodiment, the first information block only comprises the second identifier in the first identifier and the second identifier, the target identifier is equal to the second identifier, and the target reference signal resource set is the second reference signal resource set.

In one subembodiment of the embodiment, the first information block is used to indicate a given second reference signal resource from the second reference signal resource set, and the target reference signal resource is the given second reference signal resource.

In one subembodiment of the embodiment, a scheduling signaling of the second signal is used to indicate a given second reference signal resource from the second reference signal resource set, and the target reference signal resource is the given second reference signal resource.

### Embodiment 7

Embodiment 7 illustrates a flowchart of a first signaling, as shown in FIG. 7. In FIG. 7, a first node U5 and a second node N6 are in communications via a radio link. It is particularly underlined that the order illustrated in the embodiment does not put constraints over sequences of signal transmissions and implementations.

The first node U5 receives a first signaling in step S50.

The second node N6 transmits a first signaling in step S60.

In embodiment 7, the first signaling is used to determine K1 serving cells, K1 being a positive integer greater than 1, the first cell is a serving cell other than the K1 serving cells, the K1 serving cells respectively correspond to K1 cell identifiers, and the second identifier is different from any cell identifier in the K1 cell identifiers.

In one embodiment, the step S50 is taken before the step S10 in embodiment 5.

In one embodiment, the step S60 is taken before the step S20 in embodiment 5.

In one embodiment, the step S50 is taken after the step S10 and before the step S11 in embodiment 5.

In one embodiment, the step S60 is taken after the step S20 and before the step S21 in embodiment 5.

In one embodiment, the step S50 is taken before the step S30 in embodiment 6.

In one embodiment, the step S60 is taken before the step S40 in embodiment 6.

In one embodiment, the first signaling comprises an RRC signaling.

In one embodiment, the first signaling comprises a SCellToAddModList field in TS 38.331.

In one embodiment, the K1 cell identifier(s) is (are respectively) K1 SCellIndex(es).

In one embodiment, the K1 cell identifier(s) is (are respectively) K1 ServcellIndex(es).

In one embodiment, any of the K1 cell identifier(s) is a non-negative integer.

In one embodiment, any of the K1 cell identifier(s) is not greater than 32.

### Embodiment 8

Embodiment 8 illustrates a schematic diagram of a second signaling, as shown in FIG. 8. In FIG. 8, a first node U7 and a second node N8 are in communications via a radio link. It is particularly underlined that the order illustrated in the embodiment does not put constraints over sequences of signal transmissions and implementations.

The first node U7 receives a second signaling in step S70.

The second node N8 transmits a second signaling in step S80.

In embodiment 8, the second signaling is used to determine a first control resource set, and the first control resource set is associated with the first identifier and the second identifier at the same time; frequency-domain resources occupied by the second signal belong to the first control resource set, and a measurement for the first cell is used to determine the target identifier.

In one embodiment, the step S70 is taken before the step S10 in embodiment 5.

In one embodiment, the step S80 is taken before the step S20 in embodiment 5.

In one embodiment, the step S70 is taken after the step S10 and before the step S11 in embodiment 5.

In one embodiment, the step S80 is taken after the step S20 and before the step S21 in embodiment 5.

In one embodiment, the step S70 is taken before the step S30 in embodiment 6.

In one embodiment, the step S80 is taken before the step S40 in embodiment 6.

In one embodiment, the step S70 is taken after the step S50 in embodiment 7.

In one embodiment, the step S80 is taken after the step S60 in embodiment 7.

In one embodiment, the second signaling comprises an RRC signaling.

In one embodiment, the second signaling comprises ControlResourceSet in TS 38.331.

In one embodiment, the first control resource set comprises a CORESET.

In one embodiment, the first control resource set comprises a CORESET pool.

In one embodiment, the first control resource set comprises multiple CORESETs.

In one embodiment, the first control resource set is associated with a search space set.

In one embodiment, the first control resource set is associated with a search space.

In one embodiment, the first control resource set occupies subcarrier(s) corresponding to a positive integral number of Resource Block(s) (RB(s)) in frequency domain.

In one embodiment, the first control resource set occupies a positive integer number of Orthogonal Frequency Division Multiplexing (OFDM) symbol(s) in time domain.

In one embodiment, the first control resource set occupies more than one RE.

In one embodiment, the meaning of the above phrase that the first control resource set is simultaneously associated with the first identifier and the second identifier comprises: the first information block comprises a control resource set identity adopted by the first control resource set, and the first information block comprises the first identifier and the second identifier at the same time.

In one embodiment, the meaning of the above phrase that the first control resource set is simultaneously associated with the first identifier and the second identifier comprises: there exist a first MAC CE and a second MAC CE, the first MAC CE comprises a control resource set identity and the first identity adopted by the first control resource set, and the second MAC CE comprises a control resource set identity and the second identity adopted by the first control resource set.

In one embodiment, the meaning of the above phrase that the first control resource set is simultaneously associated with the first identifier and the second identifier comprises: an RRC signaling configuring the first control resource set comprises the first identifier and the second identifier at the same time.

In one embodiment, the first control resource set is associated with the first reference signal resource set and the second reference signal resource set at the same time.

In one embodiment, the first cell is associated with a first candidate reference signal resource set, and a channel measurement result for a radio signal transmitted in a reference signal resource in the first candidate reference signal resource set is not less than a first threshold, and the target identifier is the first identifier.

In one embodiment, the first cell is associated with a first candidate reference signal resource set, and a channel measurement result for a radio signal transmitted in any reference signal resource in the first candidate reference signal resource set is less than a first threshold, and the target identifier is the second identifier.

In one embodiment, the first cell is associated with a first candidate reference signal resource set and a second candidate reference signal resource set, and a channel measurement result for a radio signal transmitted in any reference signal resource in the first candidate reference resource set is less than a first threshold, a channel measurement result for a radio signal transmitted in a reference signal resource in the second candidate reference signal resource set is greater than a second threshold, and the target identifier is the second identifier.

In one embodiment, the first candidate reference signal resource set in the present application comprises at least one first candidate reference signal resource.

In one subembodiment of the embodiment, any first candidate reference signal resource comprised in the first candidate reference signal resource set comprises a CSI-RS resource or an SSB resource.

In one subembodiment of the embodiment, a reference signal transmitted in any first candidate reference signal resource comprised in the first candidate reference signal resource set is generated through the first identity.

In one subembodiment of the embodiment, a reference signal transmitted in any first candidate reference signal resource comprised in the first candidate reference signal resource set is generated through the first identifier.

In one subembodiment of the embodiment, a reference signal transmitted in the first candidate reference signal resource set is used for an RLM-related channel measurement.

In one subembodiment of the embodiment, a reference signal transmitted in the first candidate reference signal resource set is used for a Link Recovery Procedure related channel measurement.

In one embodiment, the second candidate reference signal resource set in the present application comprises at least one second candidate reference signal resource.

In one subembodiment of the embodiment, any second candidate reference signal resource comprised in the second candidate reference signal resource set comprises a CSI-RS resource or an SSB resource.

In one subembodiment of the embodiment, a reference signal transmitted in any second candidate reference signal resource comprised in the second candidate reference signal resource set is generated through the second identity.

In one subembodiment of the embodiment, a reference signal transmitted in any second candidate reference signal resource comprised in the second candidate reference signal resource set is generated through the second identifier.

In one subembodiment of the embodiment, a reference signal transmitted in the second candidate reference signal resource set is used for an RLM-related channel measurement.

In one subembodiment of the embodiment, a reference signal transmitted in the second candidate reference signal resource set is used for a Link Recovery Procedure related channel measurement.

### Embodiment 9

Embodiment 9 illustrates a schematic diagram of a target reference signal resource set, as shown in FIG. 9. In FIG. 9, the target reference signal resource set comprises M candidate reference signal resources, M being a positive integer greater than 1, and the M candidate reference signal resources respectively correspond to M beams in the figure.

In one embodiment, the M candidate reference signal resources respectively correspond to M TCIs.

In one embodiment, the M candidate reference signal resources respectively correspond to M TCI states.

In one embodiment, the M candidate reference signal resources respectively correspond to M TCI-StateIds.

In one embodiment, the M candidate reference signal resources respectively correspond to M beamforming vectors.

In one embodiment, the M candidate reference signal resources respectively correspond to M spatial receive parameters.

In one embodiment, the target reference signal resource set is the first reference signal resource set, and M candidate reference signal resources comprised in the target reference signal resource set are respectively M1 first reference signal resources comprised in the first reference signal resource set, M being equal to M1.

In one embodiment, the target reference signal resource set is the second reference signal resource set, and M candidate reference signal resources comprised in the target reference signal resource set are respectively M2 second reference signal resources comprised in the first reference signal resource set, M being equal to M2.

### Embodiment 10

Embodiment 10 illustrates a schematic diagram of a first reference signal resource set and a second reference signal resource set, as shown in FIG. 10. In FIG. 10, the first reference signal resource set comprises M1 first reference signal resource(s), and the M1 first reference signal resource set(s) corresponds (respectively correspond) to TCI-State #1 to TCI-State #M1; the second reference signal resource set comprises M2 second reference signal resource(s), and the M2 second reference signal resource set(s) corresponds (respectively correspond) to TCI-State #1 to TCI-State #M2; both the TCI-State #1 to the TCI-State #M1 are associated to a first identifier; both the TCI-State #1 to theTCI-State #M2 are associated to a second identifier.

In one embodiment, the TCI State #1 to the TCI State #M1 corresponds (respectively correspond) to M1 TCI-StateId(s).

In one embodiment, any TCI-StateId in the M1 TCI-StateId(s) is a non-negative integer.

In one embodiment, the TCI State #1 to the TCI State #M2 corresponds (respectively correspond) to M2 TCI-StateId(s).

In one embodiment, any TCI-StateId in the M2 TCI-StateId(s) is a non-negative integer.

In one embodiment, the first reference signal resource set and the second reference signal resource set are respectively associated with two CORESET Pool identifiers.

In one embodiment, the first reference signal resource set and the second reference signal resource set are respectively associated with two TRPs.

In one embodiment, the first reference signal resource set and the second reference signal resource set are respectively associated with two serving cells.

In one embodiment, M1 is a positive integer greater than 1.

In one embodiment, M2 is a positive integer greater than 1.

In one embodiment, M1 is equal to the M2.

In one embodiment, the first reference signal resource set and the second reference signal resource set are respectively associated with the first identity and the second identity in the present application.

### Embodiment 11

Embodiment 11 illustrates a schematic diagram of an application scenario, as shown in FIG. 11. In FIG. 11, the first reference signal resource set and the second reference signal resource set are respectively configured for a first cell and a second cell, and the second cell is a neighboring cell of the first cell; the second node controls the first cell and the second cell at the same time, and the first node moves in a coverage of the first cell and a coverage of the second cell.

In one embodiment, the first cell and the second cell respectively adopt two different CORESET Pool Indexes.

In one embodiment, the first cell and the second cell respectively correspond to two TRPs.

In one embodiment, the first cell and the second cell are in a connection via an X2 interface.

In one embodiment, the first cell and the second cell are in a connection via an S1 interface.

In one embodiment, there exists an ideal backhaul link between the first cell and the second cell.

In one embodiment, a PCI of the first cell is the first identity of the present application, and a PCI of the second cell is the second identity of the present application.

In one embodiment, a radio signal in a first reference signal resource in the first reference signal resource set is transmitted through the first cell.

In one embodiment, a radio signal in a second reference signal resource in the second reference signal resource set is transmitted through the second cell.

In one embodiment, the first reference signal resource set is managed by the first cell.

In one embodiment, the second reference signal resource set is managed by the second cell.

### Embodiment 12

Embodiment 12 illustrates a schematic diagram of a first identifier and a second identifier, as shown in FIG. 12. In FIG. 12, SCellConfig is used to configure the first cell, SCellConfig comprises SCellIndex1 and SCellIndex2, respectively corresponding to the first identifier and the second identifier in the present application; SCellConfigCommon and SCellConfigDedicated are comprised in SCellConfig, PCI1 and PCI2 are comprised in SCellConfigCommon, and PCI1 and PCI2 respectively correspond to the first identity and the second identity in the present application.

### Embodiment 13

Embodiment 13 illustrates a structure block diagram in a first node, as shown in FIG. 13. In FIG. 13, a first node 1300 comprises a first receiver 1301, a second receiver 1302 and a third receiver 1303.

The first receiver 1301 receives a first signal, the first signal is used to determine a first identity, and the first identity is associated with a first identifier and a second identifier;

the second receiver 1302 determines a target identifier from the first identifier or the second identifier;

the third receiver 1303 receives a second signal;

In embodiment 13, the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, the second receiver 1302 receives a first information block, the first information block is used to determine the target identifier from the first identifier and the second identifier; the first information block is a last first-type information block received by the first node before the second signal.

In one embodiment, the target identifier is a pre-defined one in the first identifier and the second identifier.

In one embodiment, the first cell is associated with a second identity, any second reference signal resource comprised in the second reference signal resource set is associated with the second identity, the second identity is different from the first identity, and the second identity and the first identity occupy a same number of bit(s).

In one embodiment, only the first identifier in the first identifier and the second identifier is associated with a first index, the first index is used to indicate the first cell, and the first index is used for cross-carrier scheduling.

In one embodiment, the first receiver 1301 receives a first signaling; the first signaling is used to determine K1 serving cells, K1 being a positive integer greater than 1, the first cell is a serving cell other than the K1 serving cells, the K1 serving cells respectively correspond to K1 cell identifiers, and the second identifier is different from any cell identifier in the K1 cell identifiers.

In one embodiment, the first receiver 1301 receives a second signaling; the second signaling is used to determine a first control resource set, and the first control resource set is associated with the first identifier and the second identifier at the same time; frequency-domain resources occupied by the second signal belong to the first control resource set, and a measurement for the first cell is used to determine the target identifier.

In one embodiment, the first receiver 1301 comprises at least first four of the antenna 452, the receiver 454, the multi-antenna receiving processor 458, the receiving processor 456 and the controller/processor 459 in Embodiment 4.

In one embodiment, the second receiver 1302 comprises at least first four of the antenna 452, the receiver 454, the multi-antenna receiving processor 458, the receiving processor 456 and the controller/processor 459 in Embodiment 4.

In one embodiment, the third receiver 1303 comprises at least first four of the antenna 452, the receiver 454, the multi-antenna receiving processor 458, the receiving processor 456 and the controller/processor 459 in Embodiment 4.

### Embodiment 14

Embodiment 14 illustrates a structure block diagram of in a second node, as shown in FIG. 14. In FIG. 14, a second node 1400 comprises a first transmitter 1401, a second transmitter 1402 and a third transmitter 1403.

The first transmitter 1401 transmits a first signal, the first signal is used to determine a first identity, the first identity is associated with a first identifier and a second identifier; and

the second transmitter 1402 determines a target identifier from the first identifier or the second identifier;

the third transmitter 1403 transmits a second signal;

In embodiment 14, the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

In one embodiment, the second transmitter 1402 transmits a first information block, the first information block is used to determine the target identifier from the first identifier and the second identifier; the first information block is a last first-type information block received by the first node before the second signal.

In one embodiment, the target identifier is a pre-defined one in the first identifier and the second identifier.

In one embodiment, the first cell is associated with a second identity, any second reference signal resource comprised in the second reference signal resource set is associated with the second identity, the second identity is different from the first identity, and the second identity and the first identity occupy a same number of bit(s).

In one embodiment, only the first identifier in the first identifier and the second identifier is associated with a first index, the first index is used to indicate the first cell, and the first index is used for cross-carrier scheduling.

In one embodiment, the first transmitter 1401 transmits a first signaling; the first signaling is used to determine K1 serving cells, K1 being a positive integer greater than 1, the first cell is a serving cell other than the K1 serving cells, the K1 serving cells respectively correspond to K1 cell identifiers, and the second identifier is different from any cell identifier in the K1 cell identifiers.

In one embodiment, the first transmitter 1401 transmits a second signaling; the second signaling is used to determine a first control resource set, and the first control resource set is associated with the first identifier and the second identifier at the same time; frequency-domain resources occupied by the second signal belong to the first control resource set, and a measurement for the first cell is used to determine the target identifier.

In one embodiment, the first transmitter 1401 comprises at least first four of the antenna 420, the transmitter 418, the multi-antenna transmitting processor 471, the transmitting processor 414 and the controller/processor 475 in embodiment 4.

In one embodiment, the second transmitter 1402 comprises at least first four of the antenna 420, the transmitter 418, the multi-antenna transmitting processor 471, the transmitting processor 414 and the controller/processor 475 in embodiment 4.

In one embodiment, the third transmitter 1403 comprises at least first four of the antenna 420, the transmitter 418, the multi-antenna transmitting processor 471, the transmitting processor 414 and the controller/processor 475 in embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, telecontrolled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signal, the first signal being used to determine a first identity, the first identity being associated with a first identifier and a second identifier;
a second receiver, determining a target identifier from the first identifier or the second identifier; and
a third receiver, receiving a second signal;
wherein the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

2. The first node according to claim 1, wherein the second receiver receives a first information block, the first information block is used to determine the target identifier from the first identifier and the second identifier; the first information block is a last first-type information block received by the first node before the second signal.

3. The first node according to claim 1, wherein the target identifier is a predefined one of the first identifier and the second identifier.

4. The first node according to claim 1, wherein time-frequency resources occupied by the second signal are used to determine the target identifier; the time-frequency resources occupied by the second signal belong to a first time-frequency resource pool, and the target identifier is the first identifier; or, the time-frequency resources occupied by the second signal belong to a second time-frequency resource pool, and the target identifier is the second identifier.

5. The first node according to claim 4, wherein the first time-frequency resource pool is a Control Resource Set (CORESET), or a CORESET pool, or a search space set; the second time-frequency resource pool is a Control Resource Set (CORESET), or a CORESET pool, or a search space set.

6. The first node according to claim 1, wherein the first cell is associated with a second identity, any second reference signal resource comprised in the second reference signal resource set is associated with the second identity, the second identity is different from the first identity, and the second identity and the first identity occupy a same number of bit(s).

7. The first node according to claim 6, wherein the meaning of the any second reference signal resource comprised in the second reference signal resource set being associated with the second identity comprises at least one of the following:
a Radio Resource Control (RRC) signaling configuring the second reference signal resource set only comprises one Physical Cell Identifier (PCI), and the PCI is the second identity;
a reference signal transmitted in any of the second reference signal resource in the second reference signal resource set is only generated by one PCI, and the PCI is the second identity;
any second reference signal resource configuring the second reference signal resource set is associated with a Transmission Configuration Indication (TCI)-State, an RRC signaling configuring the TCI-State only comprises one PCI, and the PCI is the second identity.

8. The first node according to claim 1, wherein only the first identifier in the first identifier and the second identifier is associated with a first index, the first index is used to indicate the first cell, and the first index is used for cross-carrier scheduling.

9. The first node according to claim 1, wherein the first receiver receives a first signaling; the first signaling is used to determine K1 serving cells, K1 being a positive integer greater than 1, the first cell is a serving cell other than the K1 serving cells, the K1 serving cells respectively correspond to K1 cell identifiers, and the second identifier is different from any cell identifier in the K1 cell identifiers.

10. The first node according to claim 1, wherein the first receiver receives a second signaling; the second signaling is used to determine a first control resource set, and the first control resource set is associated with the first identifier and the second identifier at the same time; frequency-domain resources occupied by the second signal belong to the first control resource set, and a measurement for the first cell is used to determine the target identifier.

11. The first node according to claim 10, wherein the first cell is associated with a first candidate reference signal resource set, and a channel measurement result for a radio signal transmitted in a reference signal resource in the first candidate reference signal resource set is not less than a first threshold, and the target identifier is the first identifier; or, the first cell is associated with a first candidate reference signal resource set, and a channel measurement result for a radio signal transmitted in any reference signal resource in the first candidate reference signal resource set is less than a first threshold, and the target identifier is the second identifier.

12. The first node according to claim 10, wherein the first cell is associated with a first candidate reference signal resource set and a second candidate reference signal resource set, and a channel measurement result for a radio signal transmitted in any reference signal resource in the first candidate reference resource set is less than a first threshold, a channel measurement result for a radio signal transmitted in a reference signal resource in the second candidate reference signal resource set is greater than a second threshold, and the target identifier is the second identifier.

13. A second node for wireless communications, comprising:
a first transmitter, transmitting a first signal, the first signal being used to determine a first identity, the first identity being associated with a first identifier and a second identifier;
a second transmitter, determining a target identifier from the first identifier or the second identifier; and
a third transmitter, transmitting a second signal;
wherein the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.

14. The second node according to claim 13, wherein
the second transmitter transmits a first information block, the first information block is used to determine the target identifier from the first identifier and the second identifier; the first information block is a last first-type information block received by the first node before the second signal.

15. The second node according to claim 13, wherein the target identifier is a predefined one of the first identifier and the second identifier.

16. The second node according to claim 13, wherein the first cell is associated with a second identity, any second reference signal resource comprised in the second reference signal resource set is associated with the second identity, the second identity is different from the first identity, and the second identity and the first identity occupy a same number of bit(s).

17. The second node according to claim 13, wherein only the first identifier in the first identifier and the second identifier is associated with a first index, the first index is used to indicate the first cell, and the first index is used for cross-carrier scheduling.

18. The second node according to claim 13, wherein
the first transmitter transmits a first signaling;
wherein the first signaling is used to determine K1 serving cells, K1 being a positive integer greater than 1, the first cell is a serving cell other than the K1 serving cells, the K1 serving cells respectively correspond to K1 cell identifiers, and the second identifier is different from any cell identifier in the K1 cell identifiers.

19. The second node according to claim 13, wherein
the first transmitter transmits a second signaling;
wherein the second signaling is used to determine a first control resource set, and the first control resource set is associated with the first identifier and the second identifier at the same time; frequency-domain resources occupied by the second signal belong to the first control resource set, and a measurement for the first cell is used to determine the target identifier.

20. A method in a first node for wireless communications, comprising:
receiving a first signal, the first signal being used to determine a first identity, the first identity being associated with a first identifier and a second identifier;
determining a target identifier from the first identifier or the second identifier; and
receiving a second signal;
wherein the first identifier and the second identifier are respectively associated with a first reference signal resource set and a second reference signal resource set, the first reference signal resource set comprises at least one first reference signal resource, and the second reference signal resource set comprises at least one second reference signal resource; only a first reference signal resource comprised in the first reference signal resource set in the first reference signal resource set and the second reference signal resource set is associated with the first identity; the first identity is a physical cell identifier of a first cell; a demodulation reference signal of a channel occupied by the second signal and a target reference signal resource are quasi-co-located, the target reference signal resource is a reference signal resource in a target reference signal resource set, and the target reference signal resource set is a reference signal resource set corresponding to the target identifier in the first reference signal resource set and second reference signal resource set; both the first identifier and the second identifier are non-negative integers, and numbers of bit(s) respectively occupied by the first identifier and the second identifier are less than a number of bit(s) occupied by the first identity.
